(19) United States
(12) Patent Application Publication
(10) Pub. No.: US 2025/0100283 A1
(43) Pub. Date: Mar. 27, 2025

(54) RECORDING DEVICE AND METHOD FOR CONTROLLING RECORDING DEVICE

(71) Applicant: SEIKO EPSON CORPORATION, Tokyo (JP)

(72) Inventors: Hiroshi SHIOBARA, MATSUMOTO-SHI (JP); Tatsuya HOSOKAWA, MATSUMOTO-SHI (JP)

(21) Appl. No.: 18/895,212

(22) Filed: Sep. 24, 2024

(30) Foreign Application Priority Data
Sep. 26, 2023 (JP) 2023-163949

(51) Int. Cl. B41J 2/165; B41J 29/17

(52) U.S. Cl. CPC B41J 2/16511; B41J 2/16507; B41J 29/17

(57) ABSTRACT

A recording device has a recording section 25 that performs recording on a medium 16, a transport section 26 that transports the medium 16, a cleaning section 31 that performs cleaning of the transport section 26, a movement body 32 that is movable, an opening and closing covers that is configured to be opened to an open state that is accessible from outside to inside of the device, and that is configured to be closed to a closed state that is not accessible from the outside to the inside of the device, and a control section, wherein the control section is executable to perform a cleaning mode that enable a cleaning space 65 to be cleaned from the outside in the opened state of the opening and closing cover and, in the cleaning mode, causes to move the movement body 32 from a position where the movement body is included in the cleaning space 65 to a position where the movement body is out of the cleaning space 65.

The present application is based on, and claims priority from JP Application Serial Number 2023-163949, filed Sep. 26, 2023, the disclosure of which is hereby incorporated by reference herein in its entirety.

### BACKGROUND

### 1. Technical Field

The present disclosure relates to a recording device such as a printer and a method for controlling the recording device.

### 2. Related Art

For example, there is an image forming device as an example of a recording device that forms an image on a recording paper as an example of a medium by ejecting ink droplets as an example of liquid from a recording head as an example of a liquid ejection head, such as JP-A-2010-180002. The image forming device is provided with a transport belt and a cleaning blade, which is an example of a cleaning section. The transport belt electrostatically attracts and transports the recording paper. The cleaning blade scrapes and removes foreign matters such as paper dust adhering to the transport belt.

The foreign matters scraped off from the transport section are likely to accumulate below the transport section. When the foreign matters are accumulated in the device, there is concern that recording on the medium may be affected. Therefore, there is a demand for an improvement in the workability of cleaning the accumulated foreign matters.

### SUMMARY

A recording device for solving the above-described problem includes a recording section that performs recording on a medium; a transport section that transports the medium; a cleaning section that performs cleaning of the transport section; a movement body that is movable; an opening and closing cover configured to open to an open state in which the inside of the device is accessible from the outside and configured to close to a closed state in which the inside of the device is not accessible from outside; and a control section; wherein the control section is configured to execute a cleaning mode that enables a cleaning space to be cleaned from the outside in the open state of the opening and closing cover and in the cleaning mode, cause the movement body to move from a position where the movement body is included in the cleaning space to a position where the movement body is out of the cleaning space.

A method for controlling a recording device that solves the above problem including a recording section that performs recording on a medium, a transport section that transports the medium, a cleaning section that performs cleaning of the transport section, a movement body that is movable, an opening and closing cover that is configured to open and close, wherein the opening and closing cover is configured to open to an open state in which the inside of the device is accessible from the outside and configured to close to a closed state in which the inside of the device is not accessible from the outside, the method for controlling the recording device includes executing a cleaning mode in which a cleaning space is cleanable from the outside in the open state and when executing the cleaning mode, moving the movement body from a position included in the cleaning space to outside of the cleaning space.

### BRIEF DESCRIPTION OF THE DRAWINGS

FIG. 1 is a perspective view of a recording device.

FIG. 2 is a schematic view of a transport belt and a cap in a first form.

FIG. 3 is a schematic view of the transport belt and the cap in a second form.

FIG. 4 is a schematic view of a transport belt and a cap in a third form.

### DESCRIPTION OF EMBODIMENTS

### Embodiment

An embodiment of a recording device and a method for controlling the recording device will be described below with reference to the drawings. The recording device is, for example, an inkjet type printer which performs recording by ejecting ink, which is an example of liquid, onto a medium such as paper, cloth, vinyl, plastic parts, or metal parts.

In the drawings, assuming that a recording device 11 is placed on a horizontal plane, the direction of gravity is indicated by a Z-axis, and directions along the horizontal plane are indicated by an X-axis and a Y-axis. The X-, Y-, and Z-axes are orthogonal to each other. In the following description, a direction parallel to the X-axis is also referred to as a width direction X, a direction parallel to the Y-axis is referred to as a depth direction Y, and a direction parallel to the Z-axis is referred to as a vertical direction z.

### Recording Device

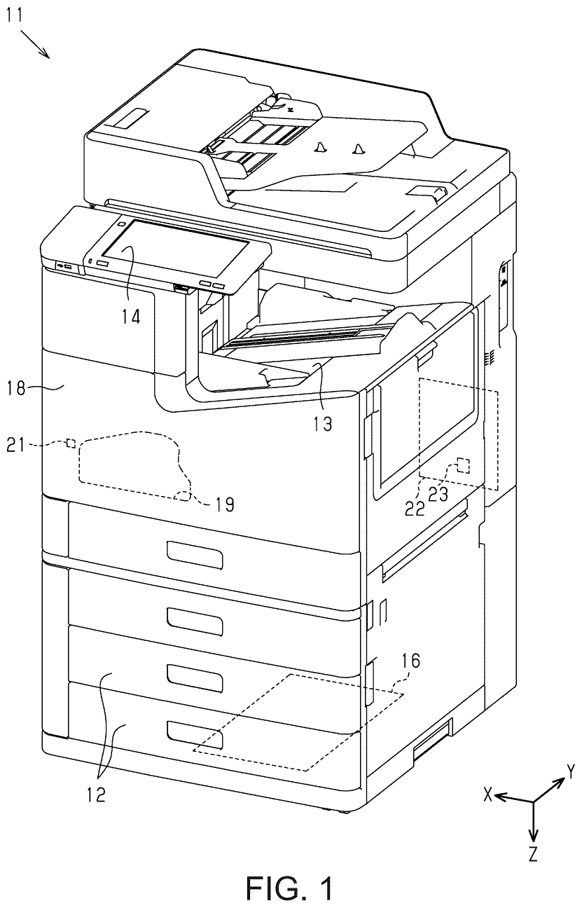

As shown in FIG. 1, the recording device 11 may include a medium accommodation section 12, a stacker 13, and a touch panel 14.

The medium accommodation section 12 can accommodate a plurality of medium 16. The stacker 13 receives a recorded medium 16. The touch panel 14 functions as an operation section that performs an operation of the recording device 11. The touch panel 14 functions as a notification section that performs notification by displaying a message, for example.

The recording device 11 is provided with an opening and closing cover 18. The opening and closing cover 18 may be provided on the front surface of the device. The opening and closing cover 18 can be opened and closed. The opening and closing cover 18 may pivot around a hinge (not shown) to move between a closed position shown in FIG. 1 and an opened position (not shown).

The opening and closing cover 18 located at the closed position covers a maintenance opening 19. A state where the opening and closing cover 18 is located in the closed position is also referred to as a closed state. The closed state disables access from outside to inside of the device.

When the opening and closing cover 18 is located at the opened position, it exposes the maintenance opening 19. A state where the opening and closing cover 18 is located at the opened position is also referred to as an open state. The open state allows access from the outside to the inside of the device. In the open state, the user can access the inside of the device through the maintenance opening 19.

The recording device 11 may include a detection section 21. The detection section 21 can detect the open state and the closed state of the opening and closing cover 18.

The recording device 11 includes a control section 22. The control section 22 generally controls drive of each mechanism in the recording device 11. The control section 22 controls various operations executed in the recording device 11.

The control section 22 can be configured as a circuit that includes a: one or more processors that execute various processes in accordance with a computer program, B: one or more dedicated hardware circuits that execute at least some of the various processes, or y: a combination thereof. The hardware circuit is, for example, an application-specific integrated circuit. The processor includes CPU and memory, such as RAM and ROM, and the memory stores program code or instructions configured to cause the CPU to execute processes. Memory, or computer readable medium, includes any readable medium that can be accessed by a general-purpose or dedicated computer.

The control section 22 may function as a count section 23 by executing a program stored in the memory. Therefore, it can be said that the recording device 11 is provided with the count section 23. The count section 23 counts number of recorded sheets. The number of recorded sheets is the number of sheets of the medium 16 on which recording has been performed. The count section 23 may count number of sheets of the medium 16 sent out from the medium accommodation section 12 as the number of recorded sheets. The count section 23 may count the number of sheets of the medium 16 discharged to the stacker 13 as the number of recorded sheets.

### Internal Configuration

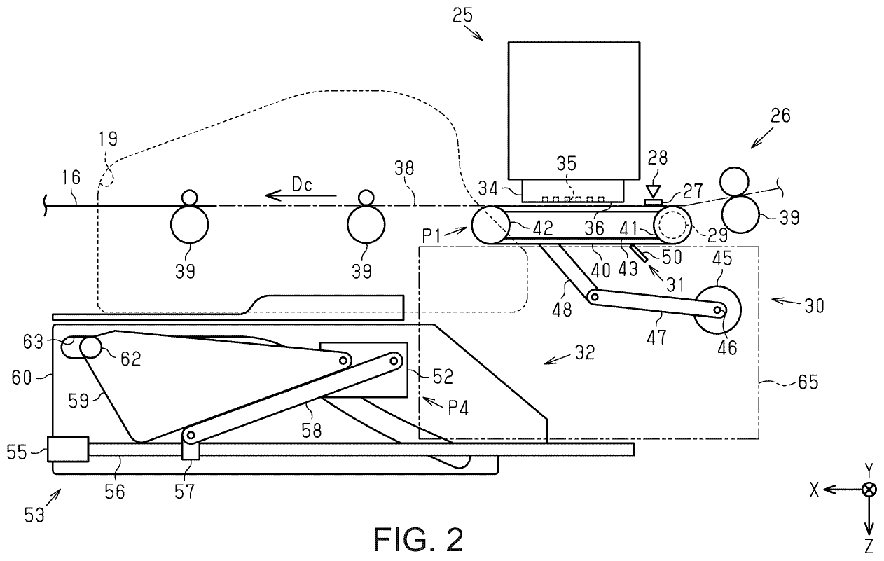

As shown in FIG. 2, the recording device 11 is provided with a recording section 25 and a transport section 26. The recording device 11 may be provided with a charge removal section 27, a transport detection section 28, a drive section 29, a displacement mechanism 30, a cleaning section 31, and a movement body 32. In FIG. 2, a location of the maintenance opening 19 is indicated by a broken line.

The recording section 25 performs recording on the medium 16. The recording section 25 may include a liquid ejection head 34. The liquid ejection head 34 can eject liquid from the nozzle 35. The liquid ejection head 34 may have a nozzle surface 36 in which a plurality of nozzles 35 are opened. The liquid ejection head 34 may be of a line type that ejects liquid in a stationary state with respect to the medium 16 being transported. The liquid ejection head 34 may be a serial type head that ejects liquid while moving.

The transport section 26 transports the medium 16. The transport section 26 transports the medium 16 along a transport path 38 indicated by a one-dot chain line in FIG. 2. The transport section 26 transports the medium 16 in the transport direction Dc. The transport direction Dc is a direction along the transport path 38. The transport section 26 may include a transport roller 39, a transport belt 40, a drive pulley 41, a driven pulley 42, and a frame body 43.

The transport section 26 may include a plurality of transport rollers 39. The transport rollers 39 transport the medium 16 by rotating in a state of sandwiching the medium 16. The transport belt 40 is an endless type belt. The transport belt 40 can face the recording section 25. The transport belt 40 is wound around the drive pulley 41 and the driven pulley 42. The frame body 43 rotatably supports both the drive pulley 41 and the driven pulley 42. The driven pulley 42 is rotatably provided. The driven pulley 42 is driven to rotate with respect to the circulating transport belt 40. The transport belt 40 transports the medium 16 by rotating while the medium 16 is electrostatically attracted.

The charge removal section 27 may be composed of a brush. The charge removal section 27 is in contact with the transport belt 40. The charge removal section 27 can come into contact with the medium 16 supported by the transport belt 40. The charge removal section 27 removes electric charges from the surface of the medium 16 being transported by the transport belt 40.

The transport detection section 28 can detect the medium 16 to be transported. The transport detection section 28 may also detect the medium 16 supported by the transport belt 40. The transport detection section 28 may also detect the medium 16 sandwiched between the transport belt 40 and the charge removal section 27.

The drive section 29 drives the transport section 26. The drive section 29 may rotate the drive pulley 41. The drive section 29 may circulate the transport belt 40 by rotating the drive pulley 41. The drive section 29 may rotate one or more transport rollers 39.

The displacement mechanism 30 may be provided with a displacement motor 45, a rotation shaft 46, a first link plate 47, and a second link plate 48.

The rotation shaft 46 rotates by driving of the displacement motor 45. One end of the first link plate 47 is fixed to the rotation shaft 46. The second link plate 48 is povitably attached to the other end of the first link plate 47. One end of the second link plate 48 is attached to the first link plate 47. The other end of the second link plate 48 is attached to the frame body 43.

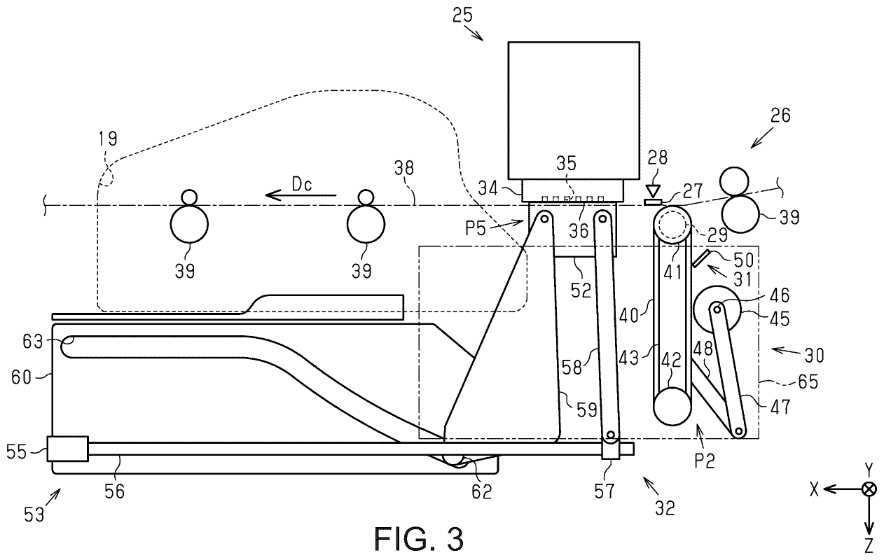

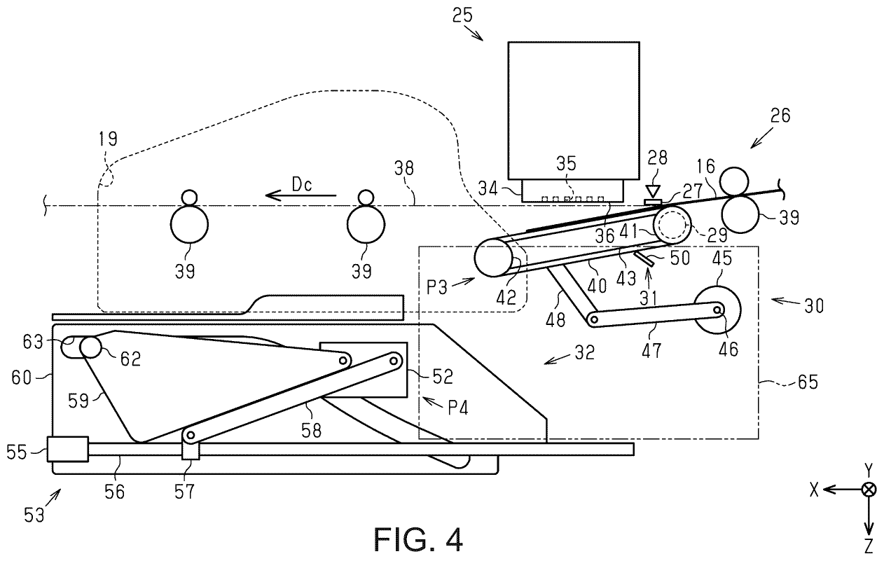

The displacement mechanism 30 may displace the transport belt 40 by pivoting the frame body 43 around the drive pulley 41. The displacement mechanism 30 displaces the transport belt 40 to a transport position P1 shown in FIG. 2, a retreat position P2 shown in FIG. 3, and a process position P3 shown in FIG. 4. The transport belt 40 may be movable to the transport position P1, the retreat position P2, and the process position P3.

As shown in FIG. 2, the transport position P1 is a position in a recording state where the recording section 25 performs recording. In the recording state, the drive pulley 41 and the driven pulley 42 are aligned in the width direction X. The transport belt 40 located at the transport position P1 faces the nozzle surface 36 with the transport path 38 interposed therebetween. The transport belt 40 supports a portion of the medium 16 in a flat state. The transport belt 40 located at the transport position P1 sandwiches the medium 16 between the transport belt 40 and the charge removal section 27.

As shown in FIG. 3, the retreat position P2 is a position in a standby state where the recording section 25 does not perform recording. In the standby state, the drive pulley 41 and the driven pulley 42 are aligned in the vertical direction Z. The retreat position P2 is a position where the transport belt 40 is separated from the recording section 25.

As shown in FIG. 4, the process position P3 is a position where, for example, a jammed medium 16 is to be processed. The process position P3 is a position between the transport position P1 and the retreat position P2. The transport belt 40 located at the process position P3 is separated from the charge removal section 27.

As shown in FIG. 2, the cleaning section 31 cleans the transport section 26. The cleaning section 31 may include a blade 50 that is capable of contacting the transport belt 40. The blade 50 may be in contact with the transport belt 40 over the depth direction Y. The blade 50 comes into contact with the circulating transport belt 40 to scrape off and clean foreign matters such as paper dust adhering to the transport belt 40. The cleaning section 31 separates foreign matters from the transport belt 40. The cleaning section 31 may be movable to the transport position P1, the retreat position P2, and the process position P3 together with the transport belt 40.

The movement body 32 is provided so as to be movable. The movement body 32 may include a cap 52 and a cap movement mechanism 53. The cap movement mechanism 53 is a mechanism for moving the cap 52. The cap 52 can move to a standby position P4 shown in FIG. 2 and to an advance position P5 shown in FIG. 3. The standby position P4 is a position when in the recording state. The advance position P5 is a position when in the standby state.

The cap movement mechanism 53 may be provided with a movement motor 55, a screw shaft 56, a slider 57, a first link member 58, a second link member 59, and a wall section 60.

The movement motor 55 is capable of both forward and reverse rotation. The screw shaft 56 can rotate in both the forward direction and the reverse direction according to the rotation of the movement motor 55. The screw shaft 56 extends in the width direction X. The slider 57 is threadably engaged with the screw shaft 56. The slider 57 moves in the width direction X or in a direction opposite to the width direction X as the screw shaft 56 rotates.

The first link member 58 connects the slider 57 and the cap 52. The second link member 59 connects the wall section 60 and the cap 52. The second link member 59 may have a guide section 62. A guide rail 63 may be formed on the wall section 60. The guide section 62 is inserted into the guide rail 63. The guide section 62 is movable along the guide rail 63.

As shown in FIG. 2, when the movement motor 55 is driven in the forward direction in a state where the cap 52 is positioned at the standby position P4, the slider 57 moves away from the movement motor 55. By this, the cap 52 rises and moves to the advance position P5. The cap movement mechanism 53 moves the cap 52 from the standby position P4 to the advance position P5 by moving the cap 52 in the horizontal and vertical directions.

As shown in FIG. 3, when the movement motor 55 is reversely driven in a state where the cap 52 is located in the advance position P5, the slider 57 moves so as to approach the movement motor 55. By this, the cap 52 descends and moves to the standby position P4.

As shown in FIG. 3, the cap 52 can cap the nozzles 35. The cap 52 caps nozzles 35 when located in the advance position P5. A portion of the cap 52 located in the advance position P5 is located in a cleaning space 65. In the cleaning space 65, the transport belt 40 that is located in the retreat position P2 is also located.

As shown in FIG. 2, the cleaning space 65 is a space located in the vertical direction Z below the transport belt 40, which is located in the transport position P1. In the drawing, the cleaning space 65 is indicated by a two dot chain line. Foreign matters separated from the transport belt 40 tends to accumulate in the cleaning space 65.

The cleaning space 65 is a space for allowing displacement of the transport belt 40. The cleaning space 65 is a space for allowing movement of the cap 52. The cleaning space 65 is connected to the maintenance opening 19. As viewed from the front surface side of the device, at least a part of the cleaning space 65 may overlap the maintenance opening 19. The cap 52 located in the standby position P4 is displaced in the width direction X from the cleaning space 65. The displacement mechanism 30 that positions the transport belt 40 at the transport position P1 is displaced in the depth direction Y from the cleaning space 65.

### Method for Controlling Cleaning Mode

As shown in FIG. 2, the control section 22 causes the transport belt 40 and the cap 52 to be in a first form during recording in which recording is performed on the medium 16. In the first form, the transport belt 40 is located in the transport position P1. In the first form, the cap 52 is located in the standby position P4.

As shown in FIG. 3, the control section 22 causes the transport belt 40 and the cap 52 to be in a second form during a standby mode when recording is not performed on the medium 16, during a sleep mode when functions of the recording device 11 is suspended, and during an off mode when the power is turned off. In the second form, the transport belt 40 is located in the retreat position P2. In the second form, the cap 52 is located in the advance position P5.

As shown in FIG. 4, the control section 22 causes the transport belt 40 and the cap 52 to be in a third form when the medium 16 is jammed around the recording section 25. In the third form, the transport belt 40 is located in the process position P3. In the third form, the cap 52 is located in the standby position P4.

The control section 22 can execute a cleaning mode. The control section 22 may receive an instruction to execute the cleaning mode from outside. The control section 22 may execute the cleaning mode according to the received execution instruction. The user may instruct execution of the cleaning mode from an external device (not shown) such as a personal computer, a smartphone, or a tablet. The user may instruct the execution of the cleaning mode by operating the touch panel 14.

When recording is performed on the medium 16, the count section 23 may count the number of recorded sheets. When the counted number of recorded sheets reaches a predetermined number, the control section 22 may execute a notification that prompts execution of the cleaning mode. When a load of the drive section 29 becomes greater than a threshold value, the control section 22 may execute a notification that prompts execution of the cleaning mode. The control section 22 may cause the touch panel 14 to notify information. The control section 22 may cause an external device to notify information.

In the cleaning mode, the cleaning space 65 can be cleaned from outside in the open state of the opening and closing cover 18. The cleaning mode is executed during the standby mode or the sleep mode. In other words, before the cleaning mode is executed, the transport belt 40 is located in the retreat position P2, and the cap 52 is located in the advance position P5.

When the cleaning mode is executed, the control section 22 changes the transport belt 40 and the cap 52 from the second form to the first form. In other words, in the cleaning mode, the movement body 32 is moved from the advance position P5, which is included in the cleaning space 65, to the outside of the cleaning space 65. In the cleaning mode, the movement body 32 is moved from an advance position P5, which is included in the cleaning space 65, to a position that is not included in the cleaning space 65. In the cleaning mode, the movement body 32 is moved from an advance position P5, which is included in the cleaning space 65, to a space that is other than the cleaning space 65. In the cleaning mode, the cap 52 is located in the standby position P4. In the cleaning mode, the transport belt 40 is located in the transport position P1. In the cleaning mode, the cleaning space 65 can be cleaned from outside in the open state of the opening and closing cover 18. The cleaning space 65 can be cleaned through the maintenance opening 19. In the cleaning of the cleaning space 65, for example, foreign matters accumulated in the cleaning space 65 may be sucked or foreign matters may be wiped away.

The control section 22 may end the cleaning mode when a predetermined time has elapsed after executing the cleaning mode. The predetermined time may be a preset time or may be a time determined by the user. After executing the cleaning mode, the detection section 21 may detect the open state and the closed state of the opening and closing cover 18. After executing the cleaning mode, the control section 22 may end the cleaning mode when the detection section 21 detects that the opening and closing cover 18 has been displaced from the open state to the closed state. Before ending the cleaning mode, the control section 22 may notify the user an end of the cleaning mode.

When ending the cleaning mode, the control section 22 causes the transport belt 40 and the cap 52 to be in the second form. In other words, the control section 22 causes to move the transport belt 40 to the retreat position P2. The control section 22 causes to move the cap 52 to the advance position P5.

### Method of Control During a Jam

If the medium 16 is jammed during recording, the control section 22 stops recording. In other words, the control section 22 stops drive of the drive section 29 and ejection of liquid from the liquid ejection head 34.

In a case where the transport detection section 28 detects the medium 16 while recording is stopped, the control section 22 may cause the transport belt 40 and the cap 52 to be in the third form. The control section 22 causes to change the from the first form to the third form. The cap 52 waits at the standby position P4. The transport belt 40 moves from the transport position P1 to the process position P3. The transport belt 40 that is located in the process position P3 directs the medium 16 that is being supported toward the maintenance opening 19. The transport belt 40 located in the process position P3 is also separated from the charge removal section 27. Therefore, the user can easily remove the medium 16 from the maintenance opening 19 while reducing the risk of the medium 16 being torn.

### Operation of Embodiment

The operation of the present embodiment will described.

The movement body 32 located in the advance position P5 is partially located in the cleaning space 65. When the cleaning mode is executed, the control section 22 causes to move the movement body 32 to the standby position P4. The user can clean the movement body 32, which may become an obstacle when cleaning the cleaning space 65, with the movement body 32 being retracted from the cleaning space 65.

### Effects of Embodiment

Effects of this embodiment will be described.

(1-1) The movement body 32 is movable into the cleaning space 65 and out of the cleaning space 65. If the movement body 32 is located in the cleaning space 65, the movement body 32 will interfere the cleaning. In this regard, when the control section 22 executes the cleaning mode, the movement body 32 moves to the outside of the cleaning space 65. Therefore, the workability of cleaning by the user can be improved.
(1-2) The control section 22 executes the cleaning mode when execution of the cleaning mode is instructed. Therefore, the user can execute the cleaning mode at an arbitrary timing.
(1-3) Accumulation of foreign matters increases in proportion to the number of recorded sheets. When the number of recorded sheets reaches a predetermined number, the control section 22 executes a notification that prompts execution of the cleaning mode. Therefore, it is possible to have the user clean the cleaning space 65 when it needs to be clean.
(1-4) If foreign matters adhere to the drive section 29, a load on the drive section 29 may increase. When the load of the drive section 29 becomes greater than a threshold value, the control section 22 executes notification that prompts execution of the cleaning mode. Therefore, it is possible to have the user clean the cleaning space 65 when it needs to be clean.
(1-5) When the transport belt 40 is cleaned, foreign matters separated from the transport belt 40 tends to accumulate below the transport belt 40. In this regard, the cleaning space 65 is located below the transport belt 40. Therefore, it is possible to have the user clean a space where foreign matters tend to accumulate.
(1-6) In the standby state, the cap 52 is located in the cleaning space 65. However, the control section 22 causes the cap 52 to move outside the cleaning space 65 by executing the cleaning mode. Therefore, even when cleaning is performed in the standby state, the cleaning work can be easily performed.
(1-7) The transport belt 40 and the cap 52 are located in the same position in the recording state and the cleaning mode. Therefore, the mechanism can be simplified compared to a case where different positions are provided for the recording state and the cleaning mode.
(1-8) The movement body 32 includes the cap movement mechanism 53. The control section 22 causes the cap 52 and the cap movement mechanism 53 to move outside the cleaning space 65 by executing the cleaning mode. Therefore, the cleaning operation can be easily performed.
(1-9) When the cap 52 is in the standby position P4, liquid in the nozzles 35 is more likely to dry. In this regard, when a predetermined time has elapsed after the cleaning mode was executed, the control section 22 causes the cap 52 to move to the advance position P5. In other words, the cap 52 that has been moved to the advance position P5 can cap the liquid ejection head 34, so that drying of the liquid can be reduced.
(1-10) The control section 22 notifies an end of the cleaning mode before a predetermined time elapses. Therefore, the user can be informed in advance that the cap 52 will move.
(1-11) The control section 22 ends the cleaning mode by triggering the opening and closing cover 18 to be closed. Therefore, the user's workability can be improved compared to having the user operate to end the cleaning mode.
(1-12) The cleaning section 31 includes the blade 50. The blade 50 can clean the transport belt 40 by scraping off the foreign matters adhering to the transport belt 40.
(1-13) The opening and closing cover 18 is provided on the front surface of the device. The user can perform cleaning work efficiently from the front surface side.

### Modifications

The present embodiment can be implemented with the following modifications. The present embodiment and the following modifications can be implemented in combination with each other within a technically compatible range.
The opening and closing cover 18 may be provided at an arbitrary position of the recording device 11. For example, the opening and closing cover 18 may be provided on a side surface of the recording device 11. The opening and closing cover 18 may be provided on the upper surface of the recording device 11.
The cleaning section 31 may include a brush that scrapes off foreign matters. The cleaning section 31 may include a vibration element that beats and drops foreign matters. The cleaning section 31 may include a web of fibers in a sheet shape. The cleaning section 31 may wipe off the foreign matters with the web.
The cleaning section 31 may clean the transport roller 39.
The detection section 21 may detect the opening and closing cover 18 located in the opened position. If the detection section 21 detects that the opening and closing cover 18 has moved from the opened position, the control section 22 may end the cleaning mode.
When executing the cleaning mode, the control section 22 may notify that the cleaning mode is in progress.
Before ending the cleaning mode, the control section 22 may end the notification that the cleaning mode is in progress.
The cap movement mechanism 53 may reciprocate the cap 52 in the width direction X. The cap movement mechanism 53 may reciprocate the cap 52 in the depth direction Y. The cap movement mechanism 53 may reciprocate the cap 52 in the vertical direction Z.
In the cleaning mode, the transport belt 40 may be located in the retreat position P2.
The recording device 11 may be configured not to be provided with the displacement mechanism 30. The transport belt 40 may be configured not to be displaced from the transport position P1.
The transport section 26 may be configured not to be provided with the transport belt 40. The transport section 26 may transport the medium 16 by a plurality of transport rollers 39. The cleaning space 65 may be a space below the transport roller 39.
The movement body 32 may include a wiper that wipes the nozzle surface 36.
The control section 22 may prompt execution of the cleaning mode when the load of the motor for moving the wiper becomes greater than a threshold value.
The cleaning section 31 may, for example, be movable to a position where it is in contact with the transport belt 40 and a position where it is separated from the transport belt 40. The position separated from the transport belt 40 may be outside of the cleaning space 65. When executing the cleaning mode, the control section 22 may cause to move the cleaning section 31 to the outside of the cleaning space 65.
At least one of the recording device 11 and the external device may include a notification section that is capable of performing notification. The notification section may include a speaker that performs notification by emitting a sound. The notification section may perform notification by playing a voice or may perform notification by emitting a warning sound or similar. The notification section may include a light that performs notification by emitting light. The notification section may perform notification by, for example, making a message stand out with light, or may perform notification by blinking light.
The recording device 11 is not limited to an inkjet type printer, and may be a laser printer, a thermal printer, a dot impact printer, a digital printing machine, or the like.
The recording device 11 may be a liquid ejection device that performs recording by ejecting or injecting a liquid other than ink. The state of the liquid that is ejected from the liquid ejection device as a minute amount of liquid droplets includes granular droplets, teardrop-shaped droplets, and a shape with a thread-like tail. Here, the liquid may be a material that can be ejected from the liquid ejection device. For example, the liquid may be in a state where a substance is in liquid phase, and includes fluid bodies such as liquid body having high or low viscosity, sols, gel waters, other inorganic solvents, organic solvents, solutions, liquid resins, liquid metals, and metallic melts. The liquid includes not only liquid as one state of substance but also liquid in which particles of functional materials made of solid materials such as pigments or metal particles are dissolved, dispersed, or mixed in a solvent. Typical examples of the liquid include ink and liquid crystal as described in the above embodiment. Here, the ink includes various liquid compositions such as general water-base ink, oil-base ink, gel ink, and hot-melt ink. As a specific example of the liquid ejection device, there is a device that ejects a liquid containing a material such as an electrode material or a color material used for manufacturing a liquid crystal display, an electroluminescence display, a surface emitting display, a color filter, or the like in a dispersed or dissolved form. The liquid ejection device may be a device that ejects living organic material used for biochip production, a device that is used as a precision pipette and ejects a liquid serving as a sample, a textile dyeing device, a micro-dispenser, or the like. The liquid ejection device may be a device that ejects lubricating oil to precision machinery such as watches or cameras in a pinpoint manner, or a device that ejects a transparent resin liquid such as ultraviolet curable resin onto a substrate in order to form micro hemispherical lenses, optical lenses, or the like used in optical communication elements or the like. The liquid ejection device may be a device that ejects etchant such as an acid or an alkali for etching a substrate or the like.

### Definition

The expression “at least one” as used in this specification means “one or more” of the desired options. As an example, the expression “at least one” as used in this specification means “only one option” or “both of the two options” if the number of options is two. As another example, the expression “at least one” as used in this specification means “only one option”, “any combination of two options”, or “any combination of three or more options” if the number of options is three or more.

### Notes

Hereinafter, technical ideas grasped from the above-described embodiment and modifications, and operations and effects thereof will be described.

(A) The recording device includes a recording section that performs recording on a medium; a transport section that transports the medium; a cleaning section that performs cleaning of the transport section; a movement body that is movable; an opening and closing cover configured to open to an open state in which the inside of the device is accessible from the outside and configured to close to a closed state in which the inside of the device is not accessible from outside; and a control section; wherein the control section is configured to execute a cleaning mode that enables a cleaning space to be cleaned from the outside in the open state of the opening and closing cover and in the cleaning mode, cause the movement body to move from a position where the movement body is included in the cleaning space to a position where the movement body is out of the cleaning space.

According to this configuration, the movement body can move into the cleaning space and out of the cleaning space. If the movement body is located in the cleaning space, the movement body becomes an obstacle to cleaning. In this regard, when the control section executes the cleaning mode, the movement body moves out of the cleaning space. Therefore, the workability of cleaning by the user can be improved.

(B) The recording device according to (A) described above may be configured such that the control section executes the cleaning mode by receiving an execution instruction of the cleaning mode from outside.

According to this configuration, the control section executes the cleaning mode when the execution of the cleaning mode is instructed. Therefore, the user can execute the cleaning mode at an arbitrary timing.

(C) The recording device according to (A) or (B) described above may be configured such that the recording device further includes a count section that counts a number of recorded sheets, wherein the control section executes, when the number of recorded sheets reaches a predetermined number of sheets, a notification that prompts execution of the cleaning mode.

Accumulation of foreign matters increases in proportion to the number of recorded sheets. According to this configuration, when the number of recorded sheets reaches the predetermined number of sheets, the control section executes the notification for prompting execution of the cleaning mode. Therefore, it is possible to have the user perform cleaning the cleaning space when it needs to be clean.

(D) The recording device according to (A) to (C) may be configured such that the recording device further includes a drive section that drives the transport section, wherein the control section executes, when a load of the drive section becomes greater than a threshold value, a notification that prompts execution of the cleaning mode.

If foreign matters adhere to the drive section, a load on the drive section may increase. According to this configuration, when the load of the drive section becomes greater than the threshold value, the control section executes the notification that prompts the execution of the cleaning mode. Therefore, it is possible to have the user perform cleaning the cleaning space when it needs to be clean.

(E) The recording device according to (A) to (D) described above may be configured such that the transport section includes a transport belt that is configured to face the recording section and the cleaning space is located below the transport belt in a vertical direction.

Foreign matters separated from the transport belt by cleaning the transport belt is likely to be accumulated below the transport belt. In this regard, according to this configuration, the cleaning space is located below the transport belt. Therefore, it is possible to have the user clean a space where foreign matters tend to accumulate.

(F) The recording device according to (E) described above may be configured such that the recording section includes a liquid ejection head that is configured to eject liquid from a nozzle, the movement body includes a cap that is configured to cap the nozzle, the transport belt is configured to move between a transport position where the transport belt is located in a recording state in which the recording section performs recording and a retreat position where the transport belt is located in a standby state in which the recording section does not perform recording, the cap is configured to move to a standby position where the cap is positioned in the recording state and to an advance position where the cap is located in the standby state, and caps the nozzle when the cap is located in the advance position, and a portion of the cap that is located in the advance position is located in the cleaning space.

According to this configuration, in the standby state, the cap is located in the cleaning space. However, the control section causes the cap to move out of the cleaning space by executing the cleaning mode. Therefore, even when cleaning is performed in the standby state, the cleaning work can be easily performed.

(G) The recording device according to (F) described above may be configured such that in the cleaning mode, the transport belt is located at the transport position, and the cap is located at the standby position.

According to this configuration, the transport belt and the cap are located at the same position in the recording state and in the cleaning mode. Therefore, the mechanism can be simplified compared to a case where different positions are provided for the recording state and the cleaning mode.

(H) The recording device according to (F) or (G) described above may be configured such that the movement body includes a cap movement mechanism that moves the cap and the cap movement mechanism is configured to move the cap from the standby position to the advance position by moving the cap in a horizontal direction and in a vertical direction.

According to this configuration, the movement body includes a cap movement mechanism. The control section causes the cap and the cap movement mechanism to move out of the cleaning space by executing the cleaning mode. Therefore, the cleaning operation can be easily performed.

(I) The recording device according to (F) to (H) described above may be configured such that when a predetermined time elapses after executing the cleaning mode, the control section ends the cleaning mode and causes the cap to move to the advance position.

When the cap waits in the standby position, liquid in the nozzles is more likely to dry. In this regard, according to this configuration, the control section causes the cap to move to the advance position when a predetermined time has elapsed after executing the cleaning mode. In other words, since the liquid ejection head can be capped by the cap that has moved to the advance position, drying of the liquid can be reduced.

(J) The recording device according to (F) to (I) described above may be configured such that the control section notifies an end of the cleaning mode before ending the cleaning mode.

According to this configuration, the control section notifies the end of the cleaning mode before the predetermined time elapses. Therefore, the user can be informed in advance that the cap will move.

(K) The recording device according to (F) to (J) described above may be configured such that the recording device further includes a detection section configured to detect the open state and the closed state of the opening and closing cover, wherein after executing the cleaning mode, when the detection section detects that the opening and closing cover was displaced from the open state to the closed state, the control section ends the cleaning mode and causes the cap to move to the advance position.

According to this configuration, the control section ends the cleaning mode by triggering the opening and closing cover to be closed. Therefore, the user's workability can be improved compared to having the user operate to end the cleaning mode.

(L) The recording device according to (E) to (K) described above may be configured such that the cleaning section includes a blade configured to contact the transport belt. According to this configuration, the cleaning section includes the blade. The blade can clean the transport belt by scraping off foreign matters adhering to the transport belt.

(M) The recording device according to (A) to (L) described above may be configured such that the opening and closing cover is provided on a front surface of the device. According to this configuration, the opening and closing cover is provided on the front surface of the device. The user can perform cleaning work efficiently from the front surface side.

(N) A method for controlling a recording device including a recording section that performs recording on a medium, a transport section that transports the medium, a cleaning section that performs cleaning of the transport section, a movement body that is movable, an opening and closing cover that is configured to open and close, wherein the opening and closing cover is configured to open to an open state in which the inside of the device is accessible from the outside and configured to close to a closed state in which the inside of the device is not accessible from the outside, the method for controlling the recording device includes executing a cleaning mode in which a cleaning space is cleanable from the outside in the open state and when executing the cleaning mode, moving the movement body from a position included in the cleaning space to outside of the cleaning space. According to this method, it is possible to achieve the same effects as those of the recording device.

(O) The method for controlling the recording device according to (N) described above may include receiving an execution instruction of the cleaning mode from outside and executing the cleaning mode according to the execution instruction. According to this method, it is possible to achieve the same effects as those of the recording device.

(P) The method for controlling the recording device according to (N) or (O) may include counting a number of recorded sheets and executing a notification that prompts execution of the cleaning mode when the counted number of recorded sheets reaches a predetermined number of sheets.

According to this method, it is possible to achieve the same effects as those of the recording device.

(Q) The method of controlling the recording device according to (N) to (P) described above, the recording device further includes a drive section that drives the transport section, the method of controlling the recording device may further include when a load of the drive section becomes larger than a threshold value, executing a notification that prompts execution of the cleaning mode.

According to this method, it is possible to achieve the same effects as those of the recording device.

(R) In the method for controlling a recording device according to (N) to (Q) described above, the recording section includes a liquid ejection head that is configured to eject liquid from a nozzle, the movement body includes a cap that is configured to cap the nozzle, the transport section includes a transport belt that is configure to face the recording section, the transport belt is configured to move between a transport position where the transport belt is located in a recording state in which the recording section performs recording and a retreat position where the transport belt is located in a standby state in which the recording section does not perform recording, the cap is configured to move to a standby position where the cap is positioned in the recording state and to an advance position where the cap is located in the standby state, and caps the nozzle when the cap is located in the advance position, and a portion of the cap located at the advance position is located in the cleaning space, the method for controlling the recording device may further include when a predetermined time elapses after executing the cleaning mode, ending the cleaning mode and moving the cap to the advance position.

According to this method, it is possible to achieve the same effects as those of the recording device.

(S) The method for controlling the recording device according to (N) to (R) may further include notifying an end of the cleaning mode before ending the cleaning mode.

According to this method, it is possible to achieve the same effects as those of the recording device.

(T) In the method for controlling a recording device according to (N) to(S) described above, the recording device further includes a detection section configured to detect the open state and the closed state of the opening and closing cover, the recording section includes a liquid ejection head that is configured to eject liquid from a nozzle, the movement body includes a cap that is configured to cap the nozzle, the transport section includes a transport belt that is configured to face the recording section and the transport belt is configured to move between a transport position where the transport belt is located in a recording state in which the recording section performs recording and a retreat position where the transport belt is located in a standby state in which the recording section does not perform recording, the cap is configured to move to a standby position where the cap is positioned in the recording state and to an advance position where the cap is located in the standby state, and caps the nozzle when the cap is located in the advance position, and a portion of the cap located at the advance position is located in the cleaning space, the method for controlling the recording device may further include after executing the cleaning mode, detecting the open state and the closed state of the opening and closing cover and when the detection section detects that the opening and closing cover was displaced from the open state to the closed state, ending the cleaning mode and moving the cap to the advance position.

According to this method, it is possible to achieve the same effects as those of the recording device.

What is claimed is:

1. A recording device comprising:
a recording section that performs recording on a medium;
a transport section that transports the medium;
a cleaning section that performs cleaning of the transport section;
a movement body that is movable;
an opening and closing cover configured to open to an open state in which the inside of the device is accessible from the outside and configured to close to a closed state in which the inside of the device is not accessible from outside; and
a control section; wherein
the control section is configured to
execute a cleaning mode that enables a cleaning space to be cleaned from the outside in the open state of the opening and closing cover and
in the cleaning mode, cause the movement body to move from a position where the movement body is included in the cleaning space to a position where the movement body is out of the cleaning space.

2. The recording device according to claim 1, wherein
the control section executes the cleaning mode by receiving an execution instruction of the cleaning mode from outside.

3. The recording device according to claim 1, further comprising:
a count section that counts a number of recorded sheets, wherein
the control section executes, when the number of recorded sheets reaches a predetermined number of sheets, a notification that prompts execution of the cleaning mode.

4. The recording device according to claim 1, further comprising:
a drive section that drives the transport section, wherein
the control section executes, when a load of the drive section becomes greater than a threshold value, a notification that prompts execution of the cleaning mode.

5. The recording device according to claim 1, wherein
the transport section includes a transport belt that is configured to face the recording section and
the cleaning space is located below the transport belt in a vertical direction.

6. The recording device according to claim 5, wherein
the recording section includes a liquid ejection head that is configured to eject liquid from a nozzle,
the movement body includes a cap that is configured to cap the nozzle,
the transport belt is configured to move between a transport position where the transport belt is located in a recording state in which the recording section performs recording and a retreat position where the transport belt is located in a standby state in which the recording section does not perform recording,
the cap is configured to move to a standby position where the cap is positioned in the recording state and to an advance position where the cap is located in the standby state, and caps the nozzle when the cap is located in the advance position, and
a portion of the cap that is located in the advance position is located in the cleaning space.

7. The recording device according to claim 6, wherein
in the cleaning mode, the transport belt is located at the transport position, and the cap is located at the standby position.

8. The recording device according to claim 7, wherein
the movement body includes a cap movement mechanism that moves the cap and
the cap movement mechanism is configured to move the cap from the standby position to the advance position by moving the cap in a horizontal direction and in a vertical direction.

9. The recording device according to claim 6, wherein
when a predetermined time elapses after executing the cleaning mode, the control section ends the cleaning mode and causes the cap to move to the advance position.

10. The recording device according to claim 9, wherein
the control section notifies an end of the cleaning mode before ending the cleaning mode.

11. The recording device according to claim 6, further comprising:
a detection section configured to detect the open state and the closed state of the opening and closing cover, wherein
after executing the cleaning mode, when the detection section detects that the opening and closing cover was displaced from the open state to the closed state, the control section ends the cleaning mode and causes the cap to move to the advance position.

12. The recording device according to claim 5, wherein
the cleaning section includes a blade configured to contact the transport belt.

13. The recording device according to claim 1, wherein
the opening and closing cover are provided on a front surface of the device.

14. A method for controlling a recording device including a recording section that performs recording on a medium, a transport section that transports the medium, a cleaning section that performs cleaning of the transport section, a movement body that is movable, and an opening and closing cover that is configured to open and close, wherein
the opening and closing cover is configured to open to an open state in which the inside of the device is accessible from the outside and configured to close to a closed state in which the inside of the device is not accessible from the outside,
the method for controlling the recording device comprising:
executing a cleaning mode in which a cleaning space is cleanable from the outside in the open state and
when executing the cleaning mode, moving the movement body from a position included in the cleaning space to outside of the cleaning space.

15. The method for controlling the recording device according to claim 14, further comprising:
receiving an execution instruction of the cleaning mode from outside and
executing the cleaning mode according to the execution instruction.

16. The method for controlling the recording device according to claim 14, further comprising:
counting a number of recorded sheets and
executing a notification that prompts execution of the cleaning mode when the counted number of recorded sheets reaches a predetermined number of sheets.

17. The method for controlling the recording device according to claim 14, the recording device further including a drive section that drives the transport section,
the method for controlling the recording device further comprising:
when a load of the drive section becomes larger than a threshold value, executing a notification that prompts execution of the cleaning mode.

18. The method for controlling a recording device according to claim 14, wherein
the recording section includes a liquid ejection head that is configured to eject liquid from a nozzle,
the movement body includes a cap that is configured to cap the nozzle,
the transport section includes a transport belt that is configured to face the recording section,
the transport belt is configured to move between a transport position where the transport belt is located in a recording state in which the recording section performs recording and a retreat position where the transport belt is located in a standby state in which the recording section does not perform recording,
the cap is configured to move to a standby position where the cap is positioned in the recording state and to an advance position where the cap is located in the standby state, and caps the nozzle when the cap is located in the advance position, and a portion of the cap located at the advance position is located in the cleaning space,
the method for controlling the recording device further comprising:
when a predetermined time elapses after executing the cleaning mode, ending the cleaning mode and moving the cap to the advance position.

19. The method for controlling the recording device according to claim 18, further comprising:
notifying an end of the cleaning mode before ending the cleaning mode.

20. The recording device control method according to claim 14, wherein
the recording device further includes a detection section configured to detect the open state and the closed state of the opening and closing cover,
the recording section includes a liquid ejection head that is configured to eject liquid from a nozzle,
the movement body includes a cap that is configured to cap the nozzle,
the transport section includes a transport belt that is configured to face the recording section,
the transport belt is configured to move between a transport position where the transport belt is located in a recording state in which the recording section performs recording and a retreat position where the transport belt is located in a standby state in which the recording section does not perform recording,
the cap is configured to move to a standby position where the cap is positioned in the recording state and to an advance position where the cap is located in the standby state, and caps the nozzle when the cap is located in the advance position, and a portion of the cap located at the advance position is located in the cleaning space,
the method for controlling the recording device further comprising:
after executing the cleaning mode, detecting the open state and the closed state of the opening and closing cover and
when the detection section detects that the opening and closing cover was displaced from the open state to the closed state, ending the cleaning mode and moving the cap to the advance position.
